(19) United States
(12) Patent Application Publication
(10) Pub. No.: US 2026/0271868 A1
(43) Pub. Date: Sep. 17, 2026

(54) APPARATUS AND METHOD FOR MONITORING A MILKING PROCESS

(71) Applicant: GEA Farm Technologies GmbH, Bönen (DE)

(72) Inventors: Otto Krone, Ibbenbüren (DE); Olaf Suhr, Oeide (DE)

(21) Appl. No.: 18/876,028

(22) PCT Filed: Jul. 12, 2023
(86) PCT No.: PCT/EP2023/069298

§ 371 Date: Dec. 17, 2024

(30) Foreign Application Priority Data
Jul. 18, 2022 (DE) 10 2022 117 866.8

(51) Int. Cl. A01J 5/01; A01J 5/04

(52) U.S. Cl. CPC A01J 5/01; A01J 5/047

(57) ABSTRACT

The invention relates to an apparatus and a method for monitoring a milking process. By providing and using a monitoring element, various operating scenarios, in particular the undesired removal of a milking cup during the milking process, can be detected and corresponding measures for preventing contamination of the milking cluster and harvested milk can be initiated. In addition, a long-term undesired drop in the vacuum in the milking system is prevented. For this purpose, the monitoring unit comprises a flow element (3), which is position-adjustably arranged inside the housing. The position of the flow element can be continuously detected by a sensor (4). It can be determined from the position states whether the milking process is running as intended.

The subject-matter of the invention relates to an apparatus and a method for monitoring a milking process. The milking process can be advantageously monitored and, if necessary, influenced therewith.

Although the invention is described below in connection with a milking system for milking cows, it should be noted that the subject-matter of the invention is also suitable, in particular, for milking systems for milking sheep, goats, llamas, camels, dromedaries, buffalos, mares, donkeys, yaks and other dairy animals. The invention can be used in robot-assisted and in fully automated, semi-automated or conventional milking systems.

Milking systems comprise a plurality of milking places. Each milking place is equipped with a milking device which has milking clusters with at least one milking cup. A milking cup is intended to be attached to a teat of the in-milk dairy animal in order to extract milk therefrom. A milking cup comprises a milking cup sleeve into which an elastically deformable teat rubber is inserted. A teat rubber does not necessarily have to be made of rubber. Other elastic materials are also suitable for forming a teat rubber. Teat rubbers made of silicon are particularly hygienic and durable.

The milking cup is open at a projecting end in order to accommodate the teat and is connected at its opposite end to a milk tube in order to draw off the collected milk. The milk tube may possibly be a short milk tube which is connected to a milking claw. The outlet of the milking claw has a fluid connection to the milk line system. The teat rubber can also be formed as one piece with a short milk tube. Such a one-piece design of a teat rubber with a milk tube is also referred to as a monoblock.

The milking process is performed through alternating application of a vacuum to a gap between the milking cup sleeve and the teat rubber. The gap is connected via a pulse line to a pulsator for this purpose. A pulse vacuum is created by switching a vacuum valve of the pulsator at a predefinable clock frequency, said pulse vacuum then prevailing in the gap.

A milking vacuum prevails in the milk line or milk tube. The milk tube has an air inlet below the milking cup. Removal of the harvested milk is supported by the inflowing air. The milking system has a corresponding vacuum system for generating the necessary vacuums.

During the milking process, the milking vacuum is applied continuously in the milk line system through to the teat rubber. The milk line system comprises at least one milk line, a milk-collecting line and possibly present milk tubes and milking claws.

The pulse vacuum is modified at a predefinable frequency. A clock cycle of the pulse vacuum comprises four phases: evacuation phase, vacuum phase, ventilation phase and pressure phase. The evacuation phase and vacuum phase together form a suction phase. The ventilation phase and pressure phase together form a rest phase. The pulse vacuum, interacting with the vacuum prevailing in the teat rubber, ensures a periodic opening and closing of the teat rubber. This is performed through alternating vacuum application to and ventilation of the gap. As a result, the teat rubber is opened in the suction phase and milk flows from the teat. Since the teat rubber is collapsed, i.e. sits tightly on the teat, in the rest phase, the teat canal is closed by the teat rubber and virtually no milk flows.

Following this phase change, no continuous milk flow takes place in a milk line. Intervals in which milk flows alternate with intervals without milk flow. An interval in which milk flows is also referred to as a milk flow phase.

The change of phases with and without milk flow essentially takes place synchronously with the clock frequency of the pulse vacuum. The length of a milk flow phase depends on the clock frequency and the proportion of a clock cycle taken up by the vacuum phase. For milking cows, a milk flow phase of 400 to 600 ms is normal with a clock length of 800 to 1200 ms.

If a milking cup is not attached to a teat during a continuously acting milking vacuum, but is lying, for example, on a dirty surface, the risk exists that dirt will be sucked in due to the continuously applied milking vacuum. This would run the risk of contamination of the already harvested milk and milking clusters. It could furthermore result in a longer-term unwanted vacuum drop in the milking system. The further milking cups of the milking cluster, for example, could also drop off the corresponding teats.

It is therefore important to be able to identify malfunctions, such as an unplanned detachment of at least one milking cup and, in this case, to interrupt the application of the milking vacuum to the milking cup sleeve.

One or more milking cups can be knocked off by an animal during a milking process if, for example, said animal is irritated by insects and attempts to repel the insects with kicks into the udder region. If the activity of the animal results in the milking cup dropping off the teat, it is possible for contamination to infiltrate the milking cup and the milk-transporting tubes and lines.

The problem further exists that vacuum failures can occur in the milking system, resulting in a further impairment of the milking process and the milking system.

The object of the invention is to provide a method and an apparatus with which the known disadvantages can be at least overcome. In particular, the risk of contamination of the milking system and specifically the harvested milk after a milking cup has been knocked off or has dropped off can be reduced. A further object is to provide an apparatus which is of simple design.

This object is achieved by the features of the independent patent claims. The dependent claims focus on advantageous developments of the invention.

An apparatus is proposed for monitoring a milking process of a dairy animal, in particular a cow. The apparatus has at least one milking cup. The harvested milk is removed from the milking cup via a milk line. A milk line within the meaning of the invention also comprises a milk tube, in particular a short milk tube and/or long milk tube. A milk line is a part of the milk line system in which a milking vacuum prevails. The milk line can flow, for example, into a collecting line into which milk lines originating from other milk teats also flow.

A monitoring unit is arranged as an intermediate element between two parts of the milk line. This element has a housing with an inlet nozzle and an outlet nozzle. Harvested milk flows through the housing of the monitoring unit in a direction from the inlet nozzle to the outlet nozzle.

A flow element is arranged in a flow path of the milk inside the housing such that its position is changeable. The flow element can be designed, for example, as a sphere. It is also possible for the flow element to be mounted flat and pivotable around an axis. The range of movement of the flow element is preferably limited by the housing.

The monitoring unit has a sensor with a defined detection area. The flow element is detectable by the sensor. In particular, it can be determined by means of the sensor whether the flow element is located inside or outside the detection area. The sensor has a signaling connection to a control unit.

If no fluid flows through the milk line, the flow element is located in a rest position outside the detection area of the sensor. During a milking process, milk and/or air flow(s) through the milk line and therefore through the monitoring unit also. If primarily air flows through the milk line, this results in a change in the position of the flow element. The forces induced by the flow of the air onto the flow element are sufficiently great to change the position of the flow element so that it enters the detection area of the sensor. In particular due to flow forces acting on the flow element which are greater than the flow resistance of the flow element, the flow element can be moved out of a rest position.

The duration of the presence of the flow element in the detection area is measured. If the duration of the presence of the flow element in the detection area exceeds a predefined reference duration, a signal is sent to the control unit. The period of time in which the flow element is present in the detection area of the sensor is an indicator of the duration of the flow of the air. If a milking cup is not located on the teat or if the milking cup has not been correctly attached to the teat, air which acts on the flow element flows through the milking cup.

The flow element is to be selected in terms of its mass and its geometry such that it does not float in milk. No essential change in position of the flow element therefore occurs due to different levels of milk in the milk line or in the housing.

A change of the phases with and without milk flow takes place during the milking process, said change being essentially synchronously dependent on the clock frequency of the pulse vacuum. For milking cows, a length of 400 to 600 ms is normal for a milk flow phase. During the milk flow phase, with a sufficiently high milk flow due to the flow of the milk/air mixture, the-induced force acting on the flow element can be so great that the position of the flow element changes such that it moves into the detection area of the sensor. Outside a milk flow phase, virtually no milk flows through the monitoring unit so that there is no resulting change in the position of the flow element so that it enters the detection area. In the transition to the next milk flow phase, the flow element again changes its position so that it enters the detection area. During a clock cycle of the pulse vacuum, the flow element can therefore be moved out of the detection area and back into the detection area even with a correctly attached milking cup and a correctly running milking process.

The invention is based on the realization that, if a substantial quantity of atmospheric air penetrates the milking cup, e.g. due to incorrectly attached or detached cups, the teat rubber remains more or less in the opened position, since the pressure inside the teat rubber increases such that the teat rubber no longer collapses. A milk/air mixture then flows permanently rather than periodically into the milk line system in the case of an incorrectly attached milking cup, or only air flows in the case of an unattached or detached milking cup.

According to the descriptions above, the detection area of the sensor is chosen such that the flow element is located in a rest position outside the detection area and moves into the detection area in the event of movement due to flow-induced forces. The detection area can alternatively be chosen such that the flow element is located inside the detection area in its rest position-without the influence of flow-induced forces- and moves out of the detection area in the event of movement due to flow-induced forces.

With the proposed apparatus, a milking process can be monitored with particularly simple means. In particular, minimal equipment is required in order to prevent contamination of milk and milk clusters. Moreover, the risk of a failure of the milking vacuum is reduced, since a detached milking cup can be quickly detected. Measures such as, for example, closing a vacuum valve, can then be initiated in order to seal off the milking cup concerned. The monitoring device is furthermore particularly simple to maintain.

According to one advantageous embodiment, the apparatus has a vacuum valve. The vacuum valve is arranged on the milk line and is intended to enable a blocking of the line and therefore prevent the flow of milk and air. The vacuum valve has a signaling connection to the control unit. The vacuum valve is activated by the control unit through corresponding signaling. A milking line can thus be disconnected from the milking vacuum without influencing the milking process on other milking cups.

According to a further advantageous embodiment, the apparatus comprises a vacuum generator which has a signaling connection to the control unit. Similar to the activation of a vacuum valve, the vacuum generator can therefore also be activated directly in order to influence the process. Particularly if a plurality of monitoring units indicate that the milking process is running incorrectly, the system can first be checked before the milking process is continued.

According to a further advantageous embodiment, the sensor is to be chosen from a group of sensors comprising optical sensors, inductive and capacitive proximity sensors, ultrasound and Hall effect sensors.

A sensor designed as an optical sensor capable of differentiating colors is particularly preferable. Such a sensor is already known for the purpose of milk analysis in milking systems. If blood or pus is present in the milk, this is detected according to the prior art by a color sensor which is sensitive to red or pus-colored components, and measures can be initiated in order to eliminate the milk contaminated with blood or pus. In order to be able to make use of a color sensor that may already be present for purposes other than milk analysis, the flow element can at least partially have a color that cannot occur in the harvested milk, for example blue. In addition to the detection of red and pus-colored components, the presence or absence of the (blue) flow element could therefore be detected with the same sensor.

In the case of an embodiment of the apparatus having a color sensor, an element is used which is already present in many cases for the purpose of milk analysis in milking systems, this having an advantageous effect in terms of an overall minimal equipment requirement.

According to a further advantageous embodiment, the flow element is provided by a sphere arranged such that its position is changeable. Since its surface is free from edges and indentations, a sphere is particularly advantageous with regard to cleaning and disinfecting the flow element.

According to an alternative advantageous embodiment, the flow element is arranged pivotably around an axis of rotation in the housing of the monitoring unit. A flow element that is pivotably mounted advantageously has a flat, projecting geometry and extends from a first to a second limit of the housing. If gravity is intended to act as a reset force for the flow element, the axis of rotation is to be aligned horizontally and orthogonally to the direction of flow of the milk.

The term “pivotably” in this context is intended to mean, in particular, that the flow element has no translational degrees of freedom, but is rotationally movable around an axis. The axis of rotation passes through the flow element on one end so that, when pivoting, the end located on the axis does not travel any distance, but only rotates. The opposite end of the flow element meanwhile travels the greatest distance along a circular path. The possible pivoting is limited by the geometry of the housing to a partial circular path.

A pivotable flow element which operates with gravity as a reset force is particularly advantageous, since no additional elements are required in order to provide a reset force and no essential pressure loss is to be expected by the flow element and associated elements to provide the reset force.

According to a further advantageous embodiment, the monitoring unit can have at least one magnet. A predefinable attractive force which draws the flow element into a specific position and therefore guarantees a return to a rest position can be provided by magnets. A magnet can be provided at a specific location in or on the housing, interacting with at least a part of the flow element. Alternatively, a magnet can be provided on the flow element and a magnetic counterpart can be provided on the housing. The arrangement in each case of a magnet on the housing and on the flow element is further possible. This embodiment can be advantageously used if a specific alignment of the monitoring unit is not practicable, for example due to spatial restrictions.

Alternatively or additionally, the monitoring unit can have a tension spring or pressure spring in order to bring the flow element into its rest position.

According to a further inventive idea, a method is proposed for monitoring a milking process of a dairy animal, in particular a cow. In this method, a milking cup is attached to a teat of the animal in order to extract milk therefrom. The milk harvested from the teat is then removed through the milking cup sleeve and a milk line connected thereto. The milk flows through a monitoring unit which is arranged as an intermediate element between two parts of the milk line. The monitoring unit comprises a housing, a flow element and a sensor. The flow element is arranged inside the housing such that its position is changeable. The sensor has a specific detection area. The flow element can be moved by flow-induced forces during the milking process. The flow element can be moved, in particular, into the detection area of the sensor and out of the detection area.

During the milking process, a milking vacuum which also acts in the milk line and in the monitoring unit is applied to remove the milk.

The method comprises the following steps:

A reference duration is first provided. The reference duration can be chosen on the basis of specific process parameters. The reference duration is related to a clock frequency of the pulse vacuum which is applied periodically in the gap between the milking cup sleeve and teats.

It is detected whether the flow element is located inside or outside the detection area of the sensor. The length of time during which the flow element is located without interruption inside or outside the detection area is first measured. This can be achieved by means of a continuous measurement.

The determined duration is compared with the provided reference duration. An evaluation unit is provided for this purpose. The difference between the determined duration and the reference duration is calculated. If the difference exceeds a predefinable value, a signal is emitted to a control unit.

The period of time during which the flow element can be present in the detection area of the sensor as a result of the process depends on the clock frequency and can be quantified as a specific proportion of a pulse clock cycle. A milk flow phase in the region of 400 to 600 ms, with a total clock length of, for example, 1100 ms, is normal for cows. The presence of the flow element in the detection area in the time with milk flow can therefore be linked to the milking process. The presence of the flow element in the detection area can therefore be tolerated up to a predefinable reference duration of, for example, 500 ms. If the measured duration of the presence of the flow element in the detection area exceeds the reference duration, this indicates that the milking cup is attached to a teat in an unplanned or incorrect manner and therefore atmospheric air can be sucked into the milking cup over a longer time period. It may be that a milking cup is lying on a dirty surface and contamination can enter the milking cup and the milk-transporting lines due to the continuously applied milking vacuum. A signal is sent to a control unit in order to prevent this.

According to the descriptions above, a signal is sent if the flow element is located in the detection area of the sensor for longer than the reference duration. It is also possible to apply the method by measuring the length of time during which the flow element is located outside the detection area of the sensor and by comparing it with a reference duration, on the basis of which a signal can be sent to a control unit.

A modification of said reference durations or intervals can be advantageous in the case of goats, sheep and other dairy animals.

With the proposed method, a milking process can be reliably monitored and controlled on one individual milking cup without influencing the milking process on other milking cups. This is implemented with particularly simple means and with elements that are in some cases already present. The knocking off or dropping off of a single milking cup can be directly determined. Contamination of milk and milk clusters can therefore be prevented.

According to one advantageous embodiment of the method, the switching of a vacuum valve which is arranged on the milk line is initiated by the signaling. This can be implemented with a vacuum valve which has a signaling connection to the control unit. The vacuum feed to the milk line concerned and to the associated milking cup can therefore be interrupted. The milking line concerned can be checked or a milking cup can be re-attached in order to prevent contamination of milk or milk clusters or a failure of the milking vacuum.

According to a further advantageous embodiment of the method, an at least temporary termination of the milking process can be initiated by the signaling.

This can be done particularly if an increased difference between the measured duration and the reference duration is indicated by a plurality of monitoring units. In this case, the system can first be checked before the milking process is continued.

The invention and the technical environment are explained in detail with reference to the figures. The figures show particularly preferred exemplary embodiments, but the invention is not to be limited thereto. The same reference signs denote the same objects, so that, where appropriate, descriptions from other figures can be additionally used. In the drawings:

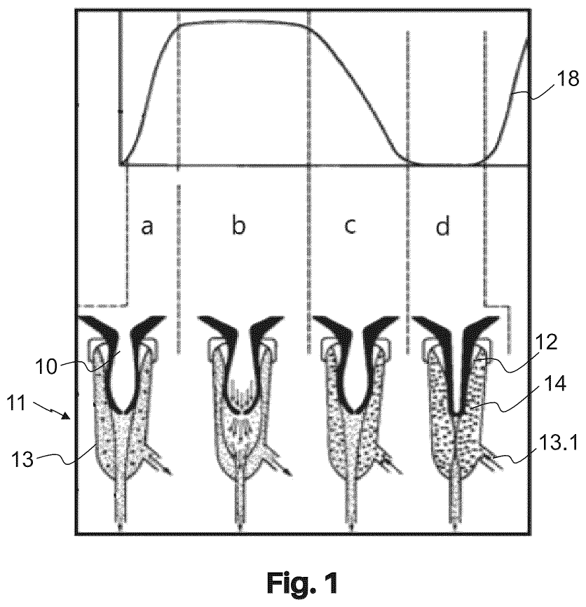

FIG. 1: shows a time characteristic of a clock cycle of the pulse vacuum with the opening states of a teat rubber resulting therefrom;

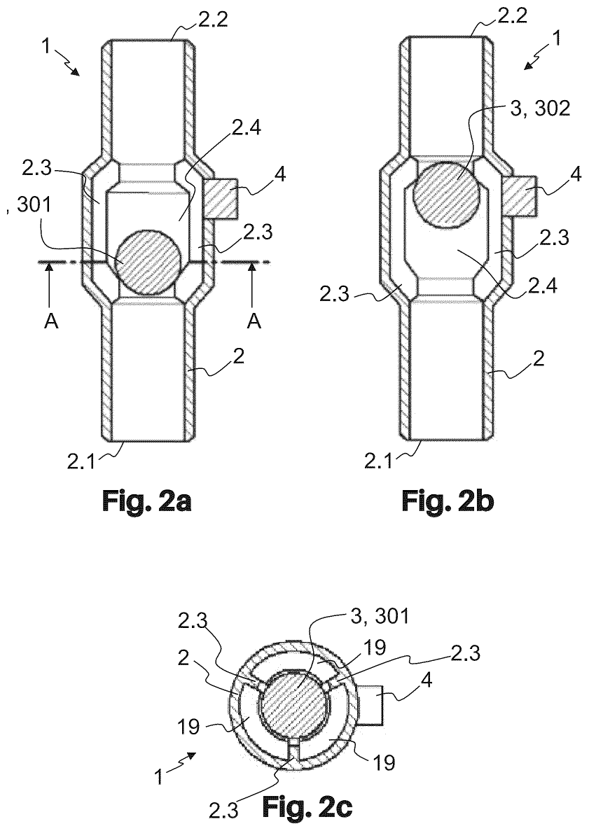

FIG. 2a: shows a schematic sectional view of a first embodiment of the monitoring unit;

FIG. 2b: shows a second schematic sectional view of the first embodiment of the monitoring unit from FIG. 2a;

FIG. 2c: shows a further schematic sectional view of the first embodiment of the monitoring unit from FIG. 2a along the line A-A;

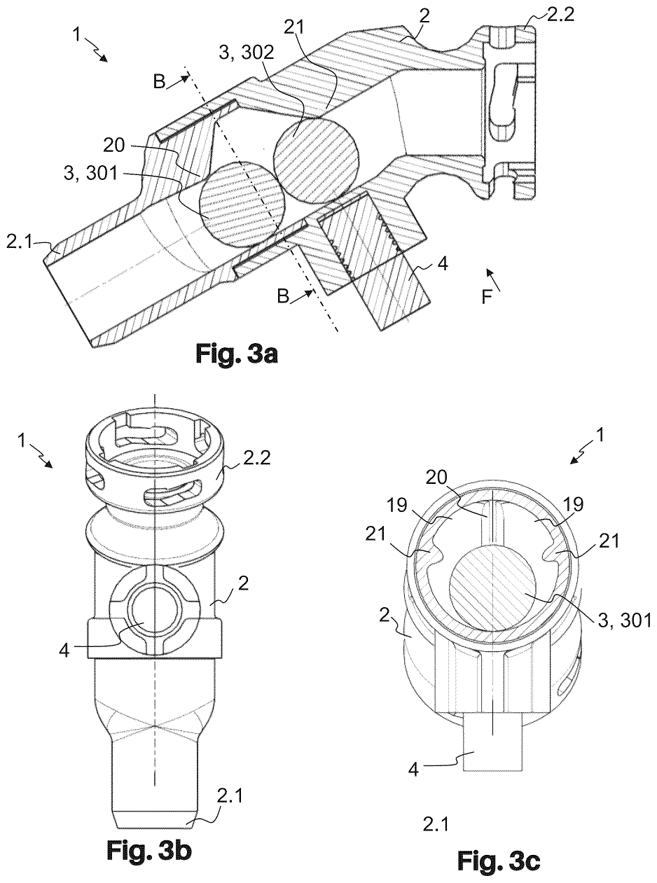

FIG. 3a: shows a schematic sectional view of a further embodiment of the monitoring unit;

FIG. 3b: shows a schematic top view of the embodiment of the monitoring unit from FIG. 3a in the direction F;

FIG. 3c: shows a further schematic sectional view of the embodiment of the monitoring unit from FIG. 3a along the line B-B;

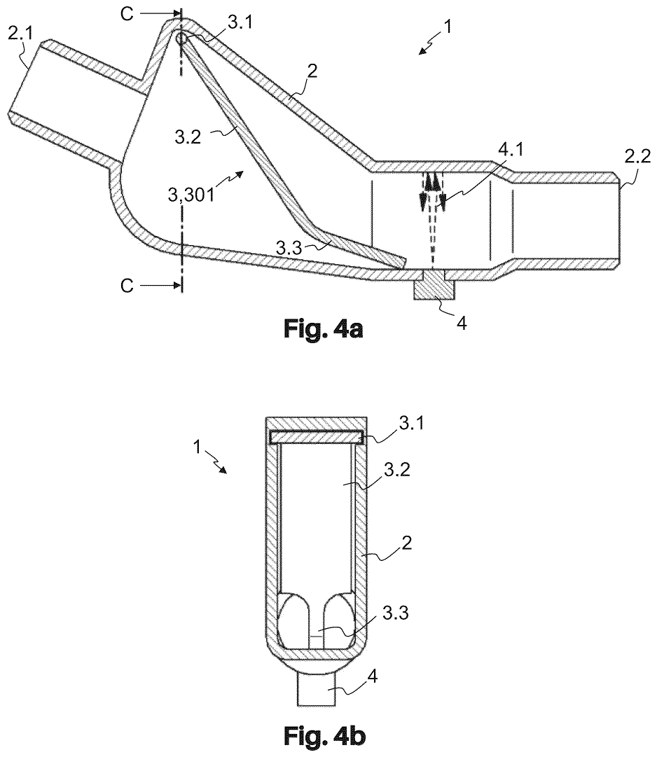

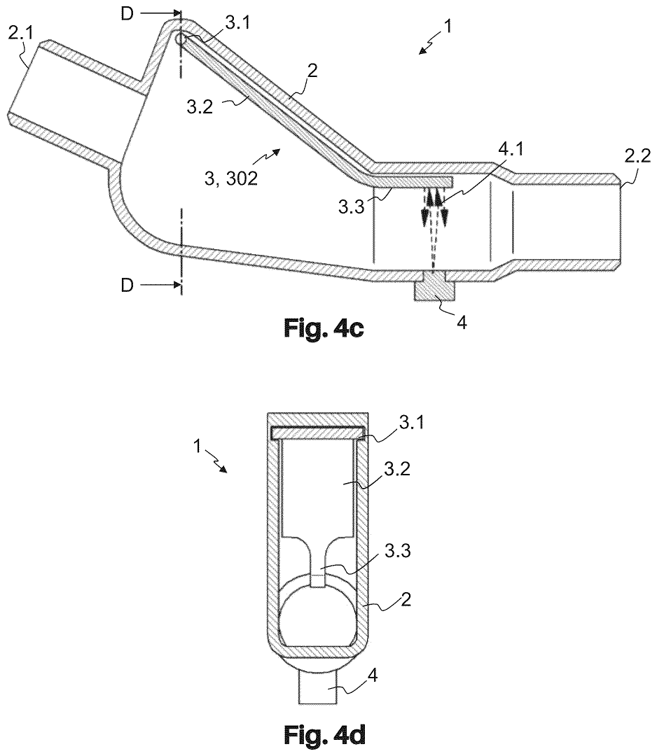

FIG. 4a: shows a schematic sectional view of a further embodiment of the monitoring unit;

FIG. 4b: shows a schematic sectional view of the embodiment of the monitoring unit from FIG. 4a along the line C-C;

FIG. 4c: shows a further schematic sectional view of the embodiment of the monitoring unit from FIG. 4a;

FIG. 4d: shows a schematic sectional view of the embodiment of the monitoring unit from FIG. 4a along the line D-D;

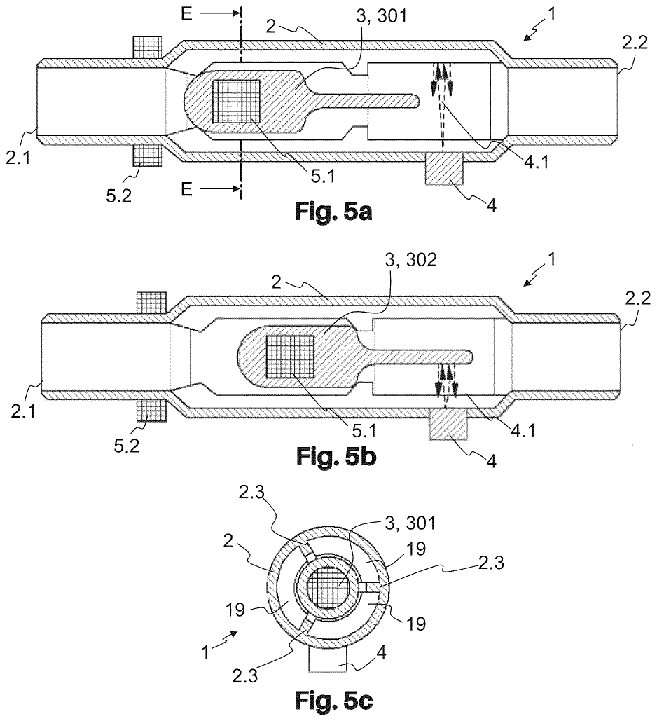

FIG. 5a: shows a schematic sectional view of a further embodiment of the monitoring unit;

FIG. 5b: shows a second schematic sectional view of the embodiment of the monitoring unit from FIG. 5a;

FIG. 5c: shows a further schematic sectional view of the embodiment of the monitoring unit from FIG. 5a along the line E-E;

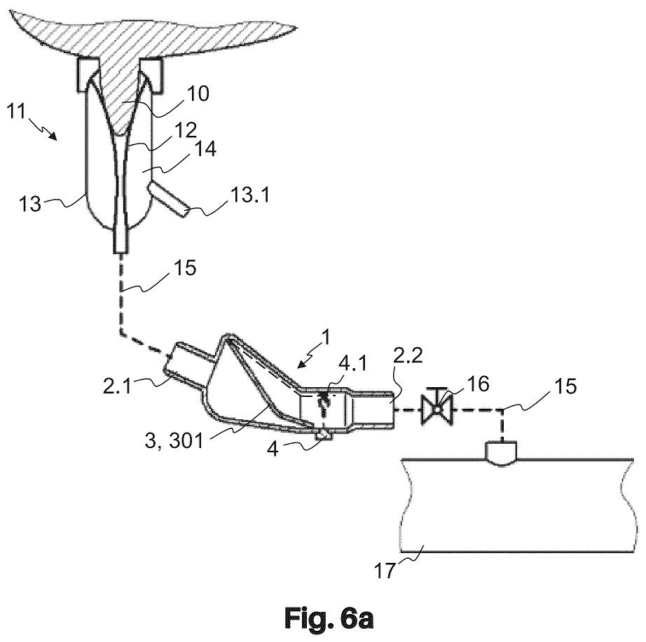

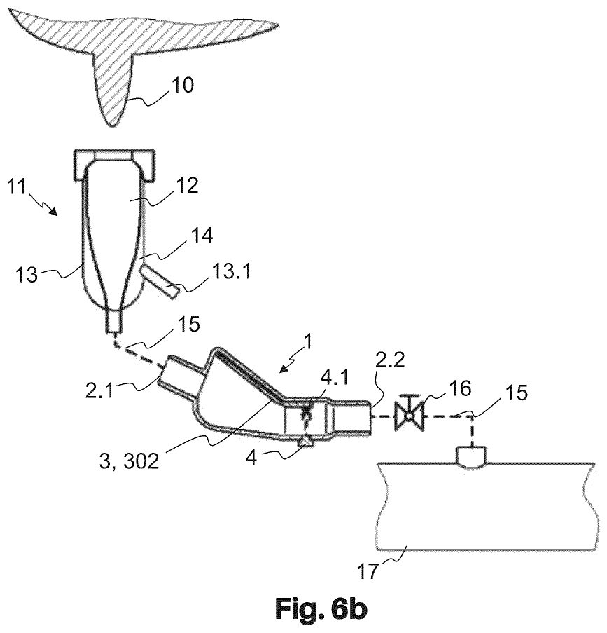

FIG. 6a: shows a schematic view of an arrangement comprising a monitoring unit;

FIG. 6b: shows a second schematic view of an arrangement comprising a monitoring unit.

The following descriptions apply to all figures, unless reference is made explicitly to one of the figures.

FIG. 1 shows a time characteristic of a clock cycle of the pulse vacuum with the opening states of a teat rubber 12 resulting therefrom. The curve 18 indicates the level of the vacuum over time. The length of a clock cycle is predefinable and is adjusted according to the animals that are to be milked. A clock length of 500 ms is common for goats and sheep. A clock length that is customary for milking cows is 800 to 1200 ms. A clock cycle comprises four phases: evacuation phase a, vacuum phase b, ventilation phase c and pressure phase d. The evacuation phase a and the vacuum phase b together form a suction phase. The ventilation phase c and pressure phase d together form a rest phase. The curve 18 relates to the pulse vacuum that is created and released in the milking cup gap 14, i.e. between the milking cup sleeve 13 and the teat rubber 12. The teat rubber 12 is connected to a milk tube. The milk tube has an air inlet below the milking cup 11. A small amount of air, in particular approximately 3 l/min, flows through this air inlet into the milk line system. The inflowing air supports the removal of the harvested milk from the milking cup.

However, the flow forces induced by this quantity of air are not yet great enough to deflect the flow element.

A vacuum is created in the evacuation phase a by removing air by means of a pulse line 13.1. The pressure in the milking cup gap 14 is equal to the pressure inside the teat rubber 12 in which the milking vacuum is continuously applied. This results in a release of tension in the teat rubber 12. During the vacuum phase b, the pressure in the milking cup gap 14 is essentially equal to the pressure inside the teat rubber 12. Milk can be harvested in this phase, since the opened teat rubber no longer exerts any mechanical pressure on the teat canal of the teat and the teat is therefore open.

In the ventilation phase c, the vacuum in the milking cup gap 14 is released by feeding air thereto via the pulse line 13.1. Since the pressure in the milking cup gap 14 then increases, while remaining constant inside the teat rubber 12, the teat rubber 12 begins to collapse. In the pressure phase d, the teat rubber 12 is collapsed due to the pressure difference and sits tightly on a teat 10 and therefore closes the teat canal of the teat so that no milk can flow.

Following this phase change, no continuous milk flow takes place in a milk line. Intervals in which milk flows alternate with intervals without milk flow. An interval in which milk flows is referred to as a milk flow phase.

The change takes place synchronously with the clock frequency of the pulse vacuum. The length of a milk flow phase depends on the clock frequency and the proportion of a clock cycle taken up by the vacuum phase b. For milking cows, a length of 400 to 600 ms is normal for a milk flow phase.

Different possible embodiments of the apparatus according to the invention are presented below.

FIGS. 2a to 2c show a first embodiment of a monitoring unit 1. The monitoring unit 1 comprises a housing 2. The housing 2 comprises a middle area 2.4 between a cylindrical inlet nozzle 2.1 and a cylindrical outlet nozzle 2.2, said middle area 2.4 similarly having a cylindrical cross section. The diameter is greater in this area than in the area of the inlet nozzle 2.1 and the outlet nozzle 2.2. A flow element 3 is arranged inside the middle area 2.4.

In this embodiment, the flow element 3 is formed by a sphere. The flow element 3 lies in a rest position 301 on one end of the middle area 2.4 adjoined by the inlet nozzle 2.1. This is shown in FIG. 2a.

In a deflected position 302, the flow element 3 is located on one end of the middle area 2.4 which is adjoined by the outlet nozzle 2.2. This is shown in FIG. 2b.

Since gravity is of functional relevance in this embodiment, the monitoring unit 1 is installed with a predefined, essentially vertical alignment. The inlet nozzle 2.1 and the outlet nozzle 2.2 should overlay one another as vertically concentric as possible, wherein the inlet nozzle 2.1 is to be arranged below the outlet nozzle 2.2.

The monitoring unit 1 comprises a sensor 4 which is to be arranged according to FIGS. 2a to 2c such that the sphere is located in the rest position 301 outside its detection area. The sensor 4 can be arranged such that the sphere is located inside the detection area of the sensor 4 in the rest position 301.

As shown in FIG. 2c, which presents a sectional view along the line A-A according to FIG. 2a, three ribs 2.3 are arranged inside the housing 2 in the middle area 2.4, said ribs 2.3 constricting the cross section such that the flow element 3 lies on them in the rest position 301 (FIG. 2a) or the flow element 3 lies adjacent to them in the deflected position 302 (FIG. 2b). The movement range within which the flow element 3 is movable is limited by the ribs 2.3. Harvested milk can flow via through-flow openings 19 between the ribs 2.3.

FIGS. 3a to 3c show a further embodiment of a monitoring unit 1 according to the invention. This comprises a housing 2 having an inlet nozzle 2.1 and an outlet nozzle 2.2. Harvested milk flows through the housing 2 in the direction of the inlet nozzle 2.1 to the outlet nozzle 2.2. The housing 2 has a first part of a bayonet lock on its outlet nozzle 2.2. The outlet nozzle 2.2 can be connected by means of this bayonet lock to a milk line which has a second part of a bayonet lock. The inlet nozzle 2.1 is designed as essentially cylindrical with a tapered end. It can be connected, for example by means of a plug-in connector, to a milk line.

The inlet nozzle 2.1 can also be designed with a bayonet lock. Alternatively or additionally, the inlet nozzle 2.1 and the outlet nozzle 2.2 can also be connected by means of pipe clamps or other connection means to parts of a milk line.

A flow element 3, which is formed as a sphere in this embodiment, is arranged in the housing 2. The flow element 3 is located in the flow path of the harvested milk. FIG. 3a shows the flow element 3 in both a rest position and a deflected position. The rest position is indicated by the reference sign 301 and the deflected position by the reference sign 302. These two states are mutually exclusive and are shown here in a single figure for illustrative purposes only.

The monitoring unit 1 has a sensor 4 with a detection area. The detection area of the sensor 4 is located inside the housing 2. The flow element 3 is detectable by the sensor 4. In FIG. 3a, the flow element 3 is located outside the detection area in the rest position 301 and inside the detection area of the sensor 4 in the deflected position 302.

In order to limit the range of movement of the sphere 301, 302, the housing 2 has a plurality of stops 20, 21. The stops 20, 21 are formed as one piece with the housing 2.

FIG. 3b shows a view of the monitoring unit 1 in the direction of view F according to FIG. 3a. In this view, the sensor 4 can be recognized from below. The sensor 4 can have a signaling connection using transmission means, for example a cable, to a control unit (not shown).

FIG. 3c shows the first embodiment of the monitoring unit 1 in a sectional view along the line B-B according to FIG. 3a. The flow element 3 is shown therein in the rest position 301 adjacent to a lower stop 20. The flow element 3 is located outside the detection area of the sensor 4. In this view, the detection area is located behind the flow element 3.

FIGS. 4a to 4d show a schematic sectional view of a further embodiment of the monitoring unit 1 according to the invention. The monitoring unit 1 has a housing 2. The housing 2 comprises a cylindrical inlet nozzle 2.1 and a cylindrical outlet nozzle 2.2. Milk which is harvested from an animal and fed to a milk container flows through the monitoring unit 1. The monitoring unit 1 is designed as an intermediate element between two parts of a milk line (not shown here).

The milk flows through the monitoring unit 1 in the direction from the inlet nozzle 2.1 to the outlet nozzle 2.2. A flow element 3 is arranged in the flow path of the milk inside the housing 2. In the exemplary embodiment according to FIGS. 4a to 4d, the flow element 3 is designed as a flat plate which has two areas 3.2 and 3.3. A bend is formed between the first area 3.2 and the second area 3.3. In the first area 3.2, the flow element 3 has a width which extends more or less over the entire width of the internal space of the housing 2 of the monitoring unit 1. In a second area 3.3, the flow element 3 has a significantly smaller width. This tapering is evident in particular from FIGS. 4b and 4d.

The flow element 3 is mounted pivotably around an axis 3.1. The radius of movement of the flow element 3 is limited by the housing 2. In the exemplary embodiment shown in FIGS. 4a to 4d, the flow element 3 is pivotable through an angle of approximately 20°. Differences in the geometry of the housing 2 shown in FIGS. 4a to 4d can result in varying pivot angles.

Since the monitoring unit 1 according to the exemplary embodiment shown in FIGS. 4a to 4d operates with the aid of gravity, it is functionally important that it is aligned during operation such that the flow element does not move into the detection area 4.1 due to gravity alone. Due to gravity, the flow element 3 is therefore located in a rest position 301 on the lower edge of the housing 2, as shown in FIGS. 4a and 4b, insofar as no flow-induced forces act on the flow element 3.

The monitoring unit 1 has a sensor 4. The sensor 4 can, in particular, be a color sensor which recognizes the color of the milk that flows through the detection area 4.1 of the sensor 4. The sensor 4 can also be designed as an ultrasound sensor, capacitive or inductive proximity sensor, Hall effect sensor or photoelectric sensor. The flow element 3 is detectable by the sensor 4. If the sensor 4 is designed as a color sensor, the flow element 3 can have a coloration at least in the second area 3.3. The flow element 3 can have, for example, a blue coloration in the second area 3.3. The color should be distinguishable from all colors which can occur in harvested milk. Harvested milk can contain blood or pus components. A red or pus-like coloration of the flow element 3 must therefore be ignored in order to prevent malfunctions in the detection of the flow element 3.

FIGS. 4a and 4b show the monitoring unit 1 with a flow element 3 located in a rest position 301. The flow element 3 is located completely outside the detection area 4.1 of the sensor 4 in the rest position 301. FIGS. 4c and 4d show the monitoring unit 1 with a flow element 3 in a deflected position 302. Here, the flow element projects into the detection area 4.1 of the sensor 4.

The arrangement of the sensor 4 in a lower area, as shown here, is particularly advantageous if the sensor 4 is a color sensor which, in addition to its function as a component of the monitoring unit 1, can also be used for milk analysis purposes. Even with little milk flow, blood and pus components can be reliably detected in the milk, since they flow directly past the sensor 4.

While air flows through the monitoring unit 1 as a result of the process, the flow element 3 can be moved momentarily thereby from the rest position 301 into the deflected position 302 and therefore into the detection area 4.1. This state is shown in FIGS. 4c and 4d. If this state persists, it can be concluded that a milking cup 11 has been knocked off and the flow element 3 is deflected by continuously flowing air.

FIGS. 5a to 5c shows a further embodiment of a monitoring unit 1. Similar to the embodiment according to FIGS. 2a to 2c, the housing 2 of this embodiment has three cylindrical sections, the middle section of which has a larger diameter than the inlet nozzle 2.1 and the outlet nozzle 2.2 which form the remaining two sections.

According to this embodiment, the flow element 3 is formed from two essentially cylindrical sections having a different diameter. The transition between the two sections is provided with a curve. The ends of the flow element 3 have a semi-spherical shape. The flow element 3 has a magnet 5.1. An annular magnet 5.2 is arranged on the housing 2.

Similar to the embodiment according to FIGS. 2a to 2c, the housing 2 has three ribs 2.3 on its inner side which are perforated by through-flow openings 19 in order to enable the harvested milk to flow past. The ribs 2.3 have the function of limiting the flow element 3 in its freedom of movement.

The flow element 3 can be moved by flow-induced forces from a rest position 301 (shown in FIG. 5a and FIG. 5c) into a deflected position 302 (shown in FIG. 5b) and therefore into the detection area 4.1 of the sensor 4.A reset force which, in this embodiment, moves the flow element 3 out of the detection area 4.1 of the sensor is provided by the two magnets 5.1 and 5.2. In principle, the monitoring unit 1 according to FIGS. 5a to 5c is therefore dependent on gravity and therefore functions independently from the chosen alignment.

A further alternative for the provision of a reset force would be the installation of a tension spring or pressure spring between the flow element 3 and the housing 2.

FIGS. 6a and 6b are representations of the apparatus for monitoring a milking process. The apparatus is substantially simplified here and is not shown true-to-scale. FIGS. 6a and 6b show an arrangement with the particularly preferred embodiment of the monitoring unit 1 according to FIGS. 4a to 4d. The descriptions relating to FIGS. 6a and 6b can be transferred accordingly to arrangements with monitoring units according to FIGS. 2a to 2c, 3a to 3c and 5a bis 5c with the corresponding flow elements. FIG. 6a shows the apparatus with a milking cup 11 attached to a teat 10.

Milk is harvested from a teat 10 of an animal. A milking cup 11 which is equipped with a milking cup sleeve 13 and a teat rubber 12 is provided for this purpose. A pulse vacuum and ventilation are applied alternately via a pulse line 13.1 to a gap 14 between the milking cup sleeve 13 and the teat rubber 12 according to the descriptions relating to FIG. 1. A vacuum feed (not shown here) is connected to the pulse line 13.1 for this purpose. The harvested milk is removed from the milking cup sleeve 13 via the first part of a milk line 15. An inlet nozzle 2.1 of the monitoring unit 1 is connected thereto. A second part of the milk line 15 is connected to an outlet nozzle 2.2. After the harvested milk initially passes through the first part of the milk line 15 and then the monitoring unit 1, it flows through the outlet nozzle 2.2 into the second part of the milk line 15. A milking vacuum is applied continuously in the milk line 15, the monitoring unit 1 and inside the teat rubber 12. A vacuum valve 16 is arranged on the milk line 15. The milking vacuum can be switched on or off by means of the vacuum valve 16.

The harvested milk is initially fed via the milk line 15 into a milk separator (not shown here). The milk is separated there from the air present in the milk line 15 as a result of the process. The milk is finally fed into a milk container 17 and is kept there for further processing.

The milking process can be monitored by the monitoring unit 1. FIG. 6a shows a scenario with an attached milking cup 11 and a flow element 3 in the rest position 301. FIG. 6b shows a scenario with an unattached milking cup 11 and a flow element 3 in the deflected position 302.

The flow element 3 is arranged in a flow path of the milk inside the housing 2 of the monitoring unit 1 such that its position is changeable. In this representation, the flow element 3 is designed as flat and pivotable around an axis. The range of movement of the flow element 3 is limited by the housing 2.

The monitoring unit 1 has a sensor 4 with a defined detection area 4.1. The flow element 3 is detectable by the sensor 4. In particular, it can be determined by means of the sensor whether the flow element 3 is located outside (FIG. 6a) or inside (FIG. 6b) the detection area 4.1. The sensor 4 has a signaling connection to a control unit (not shown here).

The flow element 3 is to be selected in terms of its mass and its geometry such that it does not float in milk. No essential change in the position of the flow element 3 therefore occurs due to different levels of milk in the housing 2. During a milking process, milk and/or air flow(s) through the milk line 15 and therefore through the monitoring unit 1 also. If primarily air flows, this results in a change in the position of the flow element 3. The forces induced by the flow of the air onto the flow element 3 are sufficiently great to change the position of the flow element 3 so that it enters the detection area 4.1 of the sensor. In particular due to flow forces acting on the flow element 3 which are greater than the flow resistance of the flow element 3, the flow element 3 can be moved out of a rest position 301.

According to the descriptions above, the detection area 4.1 of the sensor 4 is chosen such that the flow element 3 is located outside the detection area in a rest position 301 and moves into the detection area 4.1 in the event of movement due to flow-induced forces. The detection area 4.1 can alternatively be chosen such that the flow element 3 is located inside the detection area 4.1 in a rest position—without the influence of flow-induced forces—and moves out of the detection area 4.1 in the event of movement due to flow-induced forces.

A milk flow phase in the region of 400 to 600 ms, with a total clock length of, for example, 1100 ms, is normal for cows. The presence of the flow element 3 in the detection area 4.1 in the time with milk flow can therefore be attributed to the milking process and the change of phases with and without milk. The presence of the flow element 3 in the detection area 4.1 can therefore be tolerated up to a predefinable reference duration of, for example, 500 ms.

If this duration is exceeded, this is an indication of an unattached or incorrectly attached milking cup 11. In this case, air (or a milk/air mixture in the case of incorrectly attached milking cups) is sucked in through the teat rubber 12 of the milking cup 11 due to the continuously applied milking vacuum. Detection of an incorrectly attached milking cup 11 is crucially important, particularly for the performance of a hygienic milking process. A longer-term unwanted vacuum drop in the milking system is furthermore prevented.

In this case, a signal is sent to the control unit (not shown). A vacuum valve 16 arranged on the milk line 15 can then be actuated in order to disconnect the corresponding milk line 15, the monitoring unit 1 and the milking cup 11 from the applied milking vacuum.

Alternatively or additionally, the entire milking process can be interrupted. This can be advantageous if signals are sent by a plurality of monitoring units 1 indicating that the associated milking cup 11 is unattached or incorrectly attached.

The invention relates to an apparatus and a method for monitoring a milking process. Through the provision and use of a monitoring element, different operating scenarios, in particular the unwanted removal of a milking cup during the milking process can be detected and corresponding measures can be initiated to prevent contamination of the milking clusters and harvested milk. For this purpose, the monitoring unit has a flow element which is arranged inside a housing such that its position is changeable. The position of the flow element can be detected continuously by a sensor. It can be determined from the position states whether the milking process is running as intended.

### REFERENCE SIGN LIST

1 Monitoring unit
2 Housing
2.1 Inlet nozzle
2.2 Outlet nozzle
2.3 Rib
2.4 Middle area
3 Flow element
3.1 Axis
3.2 First area
3.3 Second area
4 Sensor
4.1 Detection area
5.1 First magnet
5.2 Second magnet
10 Teat
11 Milking cup
12 Teat rubber
13 Milking cup sleeve
13.1 Pulse line
14 Gap
15 Milk line
16 Vacuum valve
17 Milk container
18 Curve
19 Through-flow opening
20 Lower stop
21 Upper stop
301 Rest position
302 Deflected position
a Evacuation phase
b Vacuum phase
c Ventilation phase
d Pressure phase

1. An apparatus for monitoring a milking process of a dairy animal, in particular a cow, comprising:
at least one milking cup,
a milk line connected to the at least one milking cup,
a monitoring unit designed as an intermediate element between two parts of the milk line and having a sensor with a detection area assigned to the flow element, and
a control unit,
wherein the position of the flow element is changeable,
wherein said flow element is located outside the detection area of the sensor without the influence of flow-induced forces, and is located inside the detection area of the sensor with the influence of flow-induced forces,
wherein the monitoring unit is suitable and intended to detect the presence of the flow element in the detection area by means of the sensor and to measure the duration of the presence of the flow element in the detection area, and
wherein the sensor has a signaling connection to the control unit.

2. An apparatus for monitoring a milking process of a dairy animal, in particular a cow, comprising:
at least one milking cup,
a milk line connected to the at least one milking cup,
a monitoring unit designed as an intermediate element between two parts of the milk line and having a flow element arranged in a flow path of the milk and a sensor with a detection area assigned to the flow element, and
a control unit,
wherein the position of the flow element is changeable,
wherein said flow element is located inside the detection area of the sensor without the influence of flow-induced forces, and is located outside the detection area of the sensor with the influence of flow-induced forces,
wherein the monitoring unit is suitable and intended to detect the absence of the flow element in the detection area by means of the sensor and to measure the duration of the presence of the flow element in the detection area, and
wherein the sensor has a signaling connection to the control unit.

3. The apparatus as claimed in claim 1, wherein the milk line has a vacuum valve which has a signaling connection to the control unit.

4. The apparatus as claimed in claim 1, further comprising a vacuum system which has a signaling connection to the control unit.

5. The apparatus as claimed in claim 1, wherein the sensor is to be chosen from a group of sensors comprising optical sensors, inductive and capacitive proximity sensors, ultrasound sensors and Hall effect sensors.

6. The apparatus as claimed in claim 5, wherein the sensor is provided by an optical sensor by means of which blood components and pus components in harvested milk are detectable.

7. The apparatus as claimed in claim 1, wherein characterized in that the flow element is formed by a sphere.

8. The apparatus as claimed in claim 1, characterized in that the flow element arranged pivotably mounted in a housing.

9. The apparatus as claimed in claim 1, wherein a housing of the apparatus and/or the flow element has/have a magnet.

10. A method for monitoring a milking process of a dairy animal, in particular a cow, in which a milking cup is attached to a teat of the animal for the removal of milk, the milk is extracted from the teat through the milking cup and a milk line connected thereto, harvested milk flows through a monitoring unit which is designed as an intermediate element between two parts of the milk line, wherein a milking vacuum is applied in the milk line and in the monitoring unit during the milking process in order to remove the milk, comprising the following steps:
providing a reference duration,
detecting, by means of a sensor, two position states of a flow element arranged in the monitoring unit such that its position is changeable,
measuring the duration of the time period in which the flow element remains in at least one of the position states,
comparing the measured duration with the reference duration in an evaluation unit,
sending a signal to a control unit if a predefinable difference between the measured duration and the reference duration is exceeded.

11. The method as claimed in claim 10, wherein sending the signal initiates switching of a vacuum valve in the milk line.

12. The method as claimed in claim 10, wherein sending the signal initiates a termination of the milking process.

13. The apparatus as claimed in claim 2, wherein the milk line has a vacuum valve which has a signaling connection to the control unit.

14. The apparatus as claimed in claim 2, further comprising a vacuum system which has a signaling connection to the control unit.

15. The apparatus as claimed in claim 2, wherein the sensor is to be chosen from a group of sensors comprising optical sensors, inductive and capacitive proximity sensors, ultrasound sensors and Hall effect sensors.

16. The apparatus as claimed in claim 15, wherein the sensor is provided by an optical sensor by means of which blood components and pus components in harvested milk are detectable.

17. The apparatus as claimed in claim 2, wherein the flow element is formed by a sphere.

18. The apparatus as claimed in claim 2, characterized in that the flow element is arranged pivotably mounted in a housing.

19. The apparatus as claimed in claim 2, wherein a housing of the apparatus and/or the flow element has/have a magnet.
